(19) United States
(12) Patent Application Publication
(10) Pub. No.: US 2009/0089071 A1
(43) Pub. Date: Apr. 2, 2009

(54) COMPRESSED NON-INDEXED DATA STORAGE

(75) Inventors: Jacques Doornebos, Riverside, IL (US); Michael King, Naperville, IL (US)

Correspondence Address: BANNER & WITCOFF, LTD.,;ATTORNEYS FOR CLIENT NO. 006119, 10 SOUTH WACKER DRIVE, SUITE 3000, CHICAGO, IL, 60606, US

(73) Assignee: Chicago Mercantile Exchange, Inc., Chicago, IL (US)

(21) Appl. No.: 11/865,913

(22) Filed: Oct. 2, 2007

(51) Int. Cl. G06F 17/30; G06Q 40/00

(52) U.S. Cl. 705/1

(57) ABSTRACT

Systems and methods for storing and processing trading records are disclosed. The records may be arranged so that a single processor read operation reads multiple values. The records may also be arranged in a substantially sequential non-indexed collection and stored in a solid state memory module, such as a cache memory of a processor. A computer device may be configured to access the non-indexed collection of trading records and perform operations such as matching trades, recreating the state of an order book or analyzing trading records.

### FIELD OF THE INVENTION

The present invention relates to systems and methods that are utilized in connection with the trading of financial instruments. More particularly, trading data is arranged in a compressed non-indexed collection to facilitate rapid searching and minimize required read operations.

### DESCRIPTION OF THE RELATED ART

Modern exchanges process and monitor a large volume of trading data, such as orders for financial instruments. Large exchanges process and store large amounts of trading data every second of the trading day. Upon matching trades, exchange processors continually access and distribute market data, which is a form of trading data. The distribution of market data facilitates necessary market-driven decisions. Often large databases are utilized to store and retrieve this trading data. Numerous relatively lengthy read operations are required to read data.

To select and aggregate trading data, conventional databases often use sorts, searches, indexes, and/or disc lookups. These requirements result in significant chip clock cycles and may lead to delayed query results. Current analysis systems utilized to aggregate large quantities of trading data are often executed in batch mode overnight because of the computing resources that are consumed by these activities. The aggregation and retrieval of trading data may not be efficient enough to allow adequate information to be retrieved within the desired timeframe. Indeed, under traditional approaches, large amounts of trading data cannot be adequately analyzed in real-time, thereby preventing many uses of the data.

Prior art attempts have focused on building more intelligent indexes to speed up selection and analysis of the data stored within a database. Yet other systems have attempted to reduce response time to users through the use of pre-computed summary data. The prior art attempts to more efficiently store and retrieve trading data do not provide adequate solutions. For example, precomputed indices cannot be rapidly adapted for changing user needs or changing data. Additionally, precomputed data requires the user to specify the data that needs to be precomputed. When there is a need to analyze data from different angles or perspectives, these conventional systems fail to deliver results in a rapid fashion. Therefore, more efficient storage and searching of large amounts of data in a time sensitive manner is desirable.

### SUMMARY OF THE INVENTION

Embodiments of the present invention overcome at least some of the problems and limitations of the prior art by providing systems and methods that allow for the efficient storage, retrieval and searching of large amounts of data. Trading data may be arranged as a compressed non-indexed collection of data records within one or more computer-readable media. Exemplary computer-readable media include processor cache memories, magnetic memories, hard disk drives, flash memories, electromagnetic memories, electronic memories, and optical disk drives. Solid-state memory modules allow for rapid queries due to the lack of moving parts, such as the moving components associated with hard disk drives.

Trading data may be arranged in a computer-readable medium in a manner that facilitates rapid querying and does not require the use of an index. For example, the physical location of trading data stored in a computer-readable medium may correspond to the order in which queries are performed. If queries are created to analyze ten trading data records in sequential order, the trading data records are physically stored in sequential order. Queries may be performed by analyzing attributes of all of the trading data records, without the speed limitations and overhead associated with indexed databases. The physical locations of information associated with pending orders stored in a computer-readable medium may also or alternatively correspond to the sequence in which the pending orders were received at a match engine, an exchange, or other financial institution. Trading records may also be arranged so that a single processor read operation reads multiple values. As used herein, a “trading record” may be an order received at an exchange, market data distributed by an exchange, a status message, data representing a trade or any event record used in the trading of financial instruments.

Of course, the methods and systems disclosed herein may also include other additional elements, steps, computer-executable instructions, or computer-readable data structures. The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows an exemplary computer network system that may be used to implement aspects of the present invention.

FIG. 2 illustrates a computer-readable memory that includes trading data arranged in a compressed column based configuration, in accordance with an embodiment of the invention.

FIG. 3 illustrates a searching procedure that may be used in accordance with an embodiment of the invention.

FIG. 4 shows a data structure in which each field is allocated a portion of the computer-readable medium and each record is stored in a sequential fashion in relation to the data stored from the previous trading record, in accordance with an embodiment of the invention.

### DETAILED DESCRIPTION

### Exemplary Operating Environment

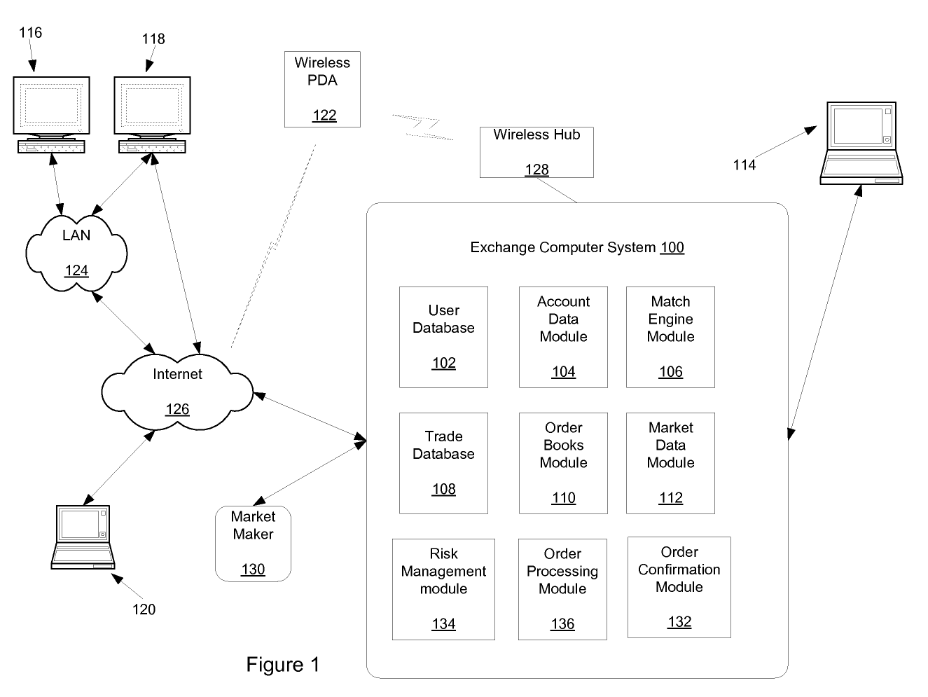

Aspects of the present invention are preferably implemented with computing devices and computer networks. The devices and networks may be configured, for example, for the exchange of trading information and data. An exemplary trading network environment for implementing trading systems and methods is shown in FIG. 1.

An exchange computer system 100 receives orders and transmits market data related to orders and trades to users. Exchange computer system 100 may be implemented with one or more mainframe, servers, gateways, desktop, notebook, handheld and/or other computing devices. In one embodiment, a computer device uses a 32-bit (or more) processor. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card, such as an Ethernet card, or modem. Each computer device may also include a variety of interface units and drives for reading and writing data or files. Depending on the type of computer device, a user can interact with the computer with a keyboard, pointing device, microphone, pen device or other input device.

Computer device 114 is shown directly coupled to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by continually providing bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

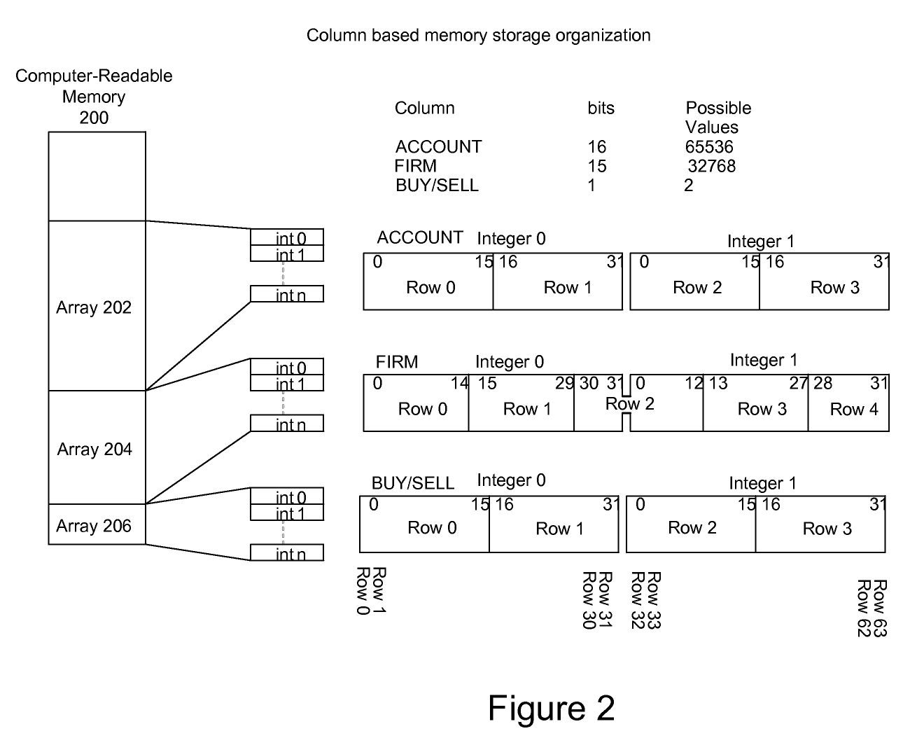

FIG. 2 illustrates a computer-readable memory 200 that includes trading data arranged in a compressed column based configuration, in accordance with an embodiment of the invention. Computer-readable memory 200 is a divided into a plurality of arrays. Array 202 includes account data for a plurality of trading records. Array 204 includes firm data for a plurality of trading records and array 206 includes data identifying whether a trading record as a buy or sell. As shown in FIG. 2, the identification of an account requires sixteen bits, the identification of a firm requires fifteen bits and the identification of a buy or sell requires one bit. In the example shown, each of the arrays includes one or more integers. An integer or 32 bits is shown because computer processors commonly read data 32 bits at a time.

A single integer may contain multiple values. For example, in array 202 integer 0 includes row 0 and row 1. Each row includes an account value. Reading a single integer (integer 0) corresponds to reading multiple account values (row 0 and row 1). Some integers may include portions of values. For example, array 204 includes integers 0 and 1. Integer 0 includes row 0, row 1 and two bits for row 2. Integer 1 includes 13 bits of row 2, row 3 and four bits of row 4. Reading two integers (integer 0 and integer 1) corresponds to reading four values (rows 0, 1, 2 and 3) and a portion of another value (row 4).

As mentioned above array 206 includes data that identifies a record as a buy or sell. Each integer includes 32 rows and each row includes a single bit that identifies a record as a buy or a sell. A single 32 bit read operation corresponds to reading 32 values.

As is well known in the art, reading data from a solid-state or physical memory device can be a relatively lengthy process. One of the advantages of the data structure shown in FIG. 2 is that it minimizes the number of read operations that are required to read data. The data may be read by a processor that will perform searching or other data processing operations.

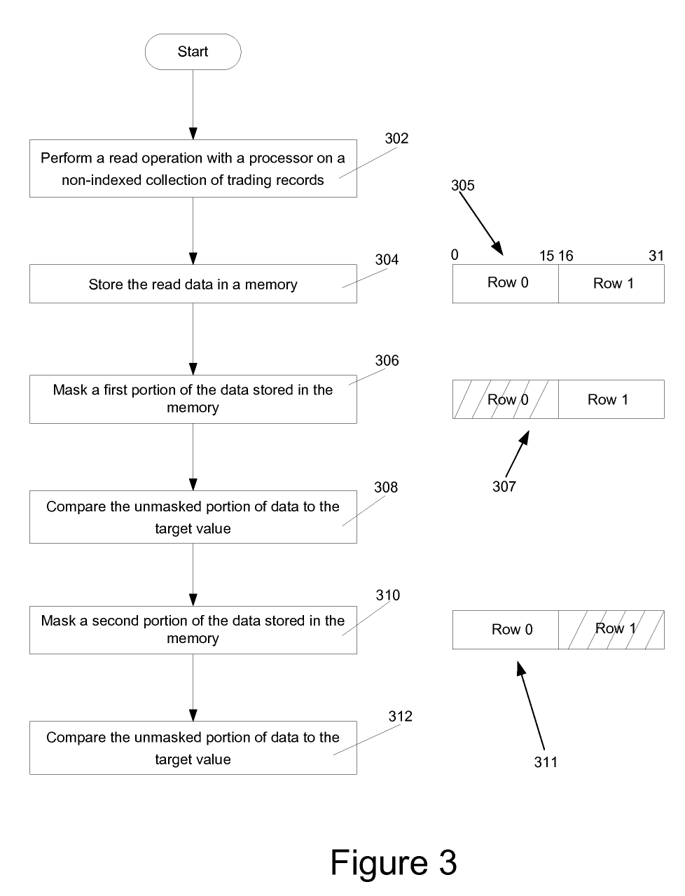

FIG. 3 illustrates a searching procedure that may be used in accordance with an embodiment of the invention. First, in step 302 a read operation is performed with a processor on a non-indexed collection of trading records. Non-indexed collections of records are described in detail below. In one embodiment of the invention the read operation includes reading 32 bits of data. Of course, other embodiments may include reading fewer or more bits of data with a single read operation. Next, in step 304 the read data is stored in the memory. The memory may be implemented with a 32-bit register. FIG. 3 shows a register 305 that includes two rows of data that are each 16 bits.

Next, a first portion of the data stored in the memory is masked in step 306. FIG. 3 shows a register 307 that includes row 0 masked and row 1 unmasked. The unmasked portion of the data is compared to a target value in step 308. For example, the target value may identify a financial instrument and financial instrument values may be included in row 0 and row 1. Step 308 may include comparing a target financial instrument value to a financial instrument value included in row 1. One skilled in the art will appreciate that conventional data processing procedures, such as shifting data in a register may be used to facilitate the comparison. Next, in step 310 a second portion of the data stored in the memory is masked. FIG. 3 shows a register 311 that includes row 0 unmasked and row 1 masked. Finally, in step 312 the unmasked portion of the data is compared to the target value.

FIG. 3 allows a single read operation to be performed on a non-indexed collection of trading records while reading multiple values. This facilitates minimizing a relatively lengthy read operations performed by processors.

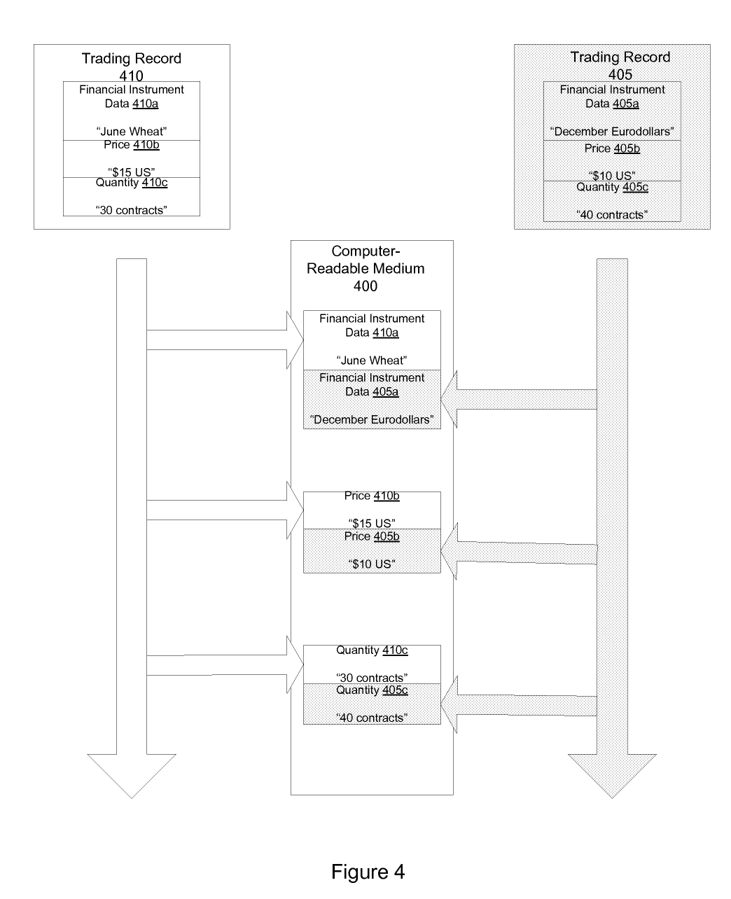

Existing database systems may have data scattered throughout a memory device and reading data from a database arranged in a scattered manner is time consuming because the reading process has to skip from one physical location to another physical location. For example, a hard disk drive must physically move a reading head from location to location. FIG. 4 shows one illustrative embodiment where each field is allocated a portion of the computer-readable medium 400 and each record is stored in a sequential fashion in relation to the data stored from the previous trading record. Unlike conventional databases, the trading data stored and as represented by trading records 405 and 410 are not associated with an index for locating the data. As additional data and/or trading records are received, they may be stored in a substantially sequential ordering. As used herein “substantial sequential ordering” means that data is physically positioned on a computer-readable medium in a direction that a read operation will follow and does not imply that a sort operation is performed on the records or data before storing. For example, data 410a is stored substantially sequential to data 405a. When computer-readable medium 400 is implemented with a hard disk drive, for example, a reading head may follow a straight path to read fields 410a and 405a.

In one embodiment, data associated with a first field of a trading record, such as financial instrument data 405a may be stored in a first location on computer-readable medium 400. Data associated with other fields of the same record is not stored substantially sequential to financial instrument data 405a, but may be placed on the computer readable memory at a different location. Upon receiving another trading record, such as trading record 410, it too may be parsed into a plurality of data associated with different fields. For simplicity, FIG. 4 shows trading record 410 subdivided according to the same fields as record 405.

As seen in FIG. 4, other matching fields of different trading records, such as trading records 405 and 410 may also be stored in the same manner. For example, price fields 405b and 410b are stored substantially sequentially wherein price data 410b is substantially sequential to and follows price data 405b. The data may be stored sequentially as it is received and in at least one embodiment is stored in real time allowing for the fast storage and manipulation of the data without having to construct and update a database-type index. Moreover, while the illustrated computer-readable memory 400 illustrates a single medium, one skilled in the art will realize a plurality of computer readable media could be utilized in other embodiments of the invention.

A collection of data organized according to the various embodiments of the present invention allows for rapid insertion speeds and is particularly useful and advantageous in real-time insertion situations, such as those routinely encountered in the trading industry. Moreover, by providing a collection of data without an associated database-type index, more space is available on the computer-readable medium to store data, such as trading records. An increases in data storage may be achieved by eliminating the use of a conventional database-type index. In at least one implementation, the elimination of an index may double the amount of data that may be stored on the computer readable memory.

Embodiments of the invention also relate to methods of performing a query on a computer readable medium, such as computer readable mediums having data stored in accordance with several or all of the steps and embodiments discussed in regards to FIGS. 2-4. In one embodiment, the query relates to a method of processing an order received at a match engine. An order for at least one financial instrument may be received at a match engine, which may be implemented, for example, with match engine module 106.

Since there is no database-type index in various embodiments of the invention, the data within trading records may be analyzed from different angles or perspectives at a more rapid pace than utilizing conventional database structures. Indeed, in some situations certain fields of data are unlikely to have data to meet the query being searched. For example, if the query relates to the quantity of financial instrument fields, a query against data located in currency fields is unlikely to yield useful information in many cases. Searching a collection of data arranged such that records or fields are physically located next to one another in a memory module in the direction of a read operation of the search allows for faster query execution when compared to queries performed on indexed databases having records or fields distributed throughout a memory module.

Yet in other embodiments, only distinct portions of trading records may be queried. For example, in one embodiment the pending orders may be organized as set forth in FIG. 4, wherein a plurality of trading records are stored wherein matching fields of different trading records, such as trading records 405 and 410 are stored in a substantially sequential fashion without an associated database-like index. For example, price fields 405b and 410b are stored sequentially and wherein price field 410b is substantially sequential to and follows price field 405b. According to one embodiment of the invention, only data categorized as having certain fields will be queried. This determination may be based on a user-input, an algorithm, or a combination of user preference and a function of one or software applications.

This can be more readily seen when reviewing FIG. 4. If a query is directed towards the price of a pending order, the comparison of the query and the data stored on the computer readable medium may be initiated at beginning of price data 405b and proceed in a substantially sequential fashion to price data 410b and through any additional price data located following price data 410b. The searching and comparison of the price data within the compared data will be performed without the use of a database-like index and will go in the sequential manner as described above. As stated above, the individual trading records, such as 405 and 410 as well as the individual fields of data such as 405a and 405b may be of a fixed length, thereby allowing a user and/or computer device to readily and accurately estimate the time to conduct the query of the trading records and/or individual data fields.

The speed at which queries may be performed when trading records are arranged as described above may be taken advantage of for other exchange and trading related activities. For example, traders, trading firms and exchange regulatory or enforcement divisions may wish to recreate the state of a market, such as pending bids and offers, at a given time. One conventional approach includes recording a snapshot of the state of the market for every change in the market. These snapshots require large amounts of storage space, even for data parameters that may not have changed since the last snapshot.

In accordance with one embodiment of the invention, a trading firm, exchange or other entity may record trading records in a non-indexed collection of data, as described above. The speed at which such a collection may be queried and processed allows such entities to quickly recreate the state of the market for any time period. For example, an initial state of the market may first be determined and then all of the orders placed at an exchange may be processed in the same manner that they would be processed by an exchange until the desired point in time. All of the incoming orders received at an exchange may be stored sequentially in one or more memory modules as a non-indexed collection of orders such that the physical location of the orders corresponds to the order in which they were received. A computer device may then be programmed to retrieve the orders and recreate the state of the market.

Unlike conventional indexed databases storing and retrieving trading data according to one or more methods of the present invention does not require large quantities of trading data to be executed in batch mode overnight. Indeed, under traditional approaches, large amounts of data could not be adequately analyzed in real-time, thereby preventing many uses of the data. Under select embodiments of the invention, the analysis of the data sequentially stored on the computer readable memory can be continually processed in real-time to monitor activity while new data is being written to the computer readable medium, all without having to create, update, and maintain a space-consuming database index and constant interruption to jump physical locations within the computer readable medium to locate a certain data piece.

Recreating market conditions may be readily accessible by querying methods, for example, as described above. Indeed, by following one or more embodiments of the invention, the analysis of the data sequentially stored on the computer readable memory can be continually processed in real-time to monitor activity while new data is being written to the computer-readable medium, all without having to create, update, and maintain a space-consuming database index and constant interruption to jump physical locations within the computer readable medium to locate a certain data piece.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. For example, aspects of the invention may be applied to data collections that are not related to exchanges or trading. All are considered within the sphere, spirit, and scope of the invention.

We claim:

1. A computer implemented method of searching a non-indexed collection of trading records, the method comprising:
(a) performing a single read operation with a processor on the non-indexed collection of trading records and storing the read data in a memory;
(b) comparing a first segment of data stored in the memory to a target value; and
(c) comparing a second segment of data stored in the memory to a target value.

2. The method of claim 1, wherein the first segment of data comprises a field of a first trading record and the second segment of data comprises a corresponding field of a second trading record.

3. The method of claim 1, wherein the single read operation comprises reading 32 bits of data.

4. The method of claim 1, wherein the non-indexed collection of trading records in (a) are stored in a hard-disk drive.

5. The method of claim 1, wherein the non-indexed collection of trading records in (a) are stored in a solid-state memory module.

6. The method of claim 1, further including:
(d) comparing a third segment of data stored in the memory to a target value.

7. The method of claim 1, where (b) comprises:
masking a first portion of the data stored in the memory; and
comparing the unmasked portion of data to the target value.

8. The method of claim 7, wherein (c) comprises:
masking a second portion of data stored in the memory; and
comparing the unmasked portion of data to the target value.

9. A computer-implemented method of storing trading data on a computer-readable medium, the method comprising:
receiving a plurality of electronic trading records;
storing first field of a first trading record in a segment of a non-indexed collection of trading records in a computer-readable medium; and
storing a first field of a second trading next to the first field of the first trading record so that the first field of the first trading record and the first field of the second trading record are retrievable by a single processor read operation.

10. The method of claim 9, wherein the single processor read operation comprises reading 32 bits of data.

11. The method of claim 9, wherein the computer-readable medium comprises a hard-disk drive.

12. The method of claim 9, wherein the computer-readable medium comprises a solid-state memory module.

13. A system for processing trading records, the system comprising:
a non-indexed collection of trading records stored in a computer-readable medium;
a processor programmed with computer-executable instructions to perform the steps comprising:
(a) performing a single read operation with a processor on the non-indexed collection of trading records and storing the read data in a memory;
(b) comparing a first segment of data stored in the memory to a target value; and
(c) comparing a second segment of data stored in the memory to a target value.

14. The system of claim 13, wherein the target value comprises a portion of an order for a financial instruction.

15. The system of claim 13, wherein the computer-readable medium comprises a hard-disk drive.

16. The system of claim 13, wherein the computer-readable medium comprises a solid-state memory module.
